(19) United States
(12) Patent Application Publication
(10) Pub. No.: US 2026/0367715 A1
(43) Pub. Date: Nov. 19, 2026

(54) KEYSWITCH AND KEYBOARD THEREOF

(71) Applicant: DARFON ELECTRONICS CORP., Taoyuan City (TW)

(72) Inventors: Po-Wei Tsai, Taoyuan City (TW); Hsiao-Han Chu, Taoyuan City (TW); Jan-Don Jane, Taoyuan City (TW)

(73) Assignee: DARFON ELECTRONICS CORP., Taoyuan City (TW)

(21) Appl. No.: 19/670,021

(22) Filed: May 7, 2026

(30) Foreign Application Priority Data
May 15, 2025 (TW) 114118287

(51) Int. Cl. G06F 3/02

(52) U.S. Cl. CPC G06F 3/0202

(57) ABSTRACT

A keyswitch includes a keycap, a lifting mechanism and a baseplate. The lifting mechanism is disposed under the keycap and includes first and second support members intersecting with each other and being movably connected to the keycap. The first support member has a sliding shaft and a first avoiding notch. The second support member has a pivot shaft and a second avoiding notch for accommodating a recessed corner of the keycap with the first avoiding notch. The baseplate has first and second hole structures respectively corresponding to the sliding and pivot shafts and bridges the first and second hole structures to form first and second arch bridge structures respectively. The sliding shaft abuts movably under a first tongue sheet of the first arch bridge structure, and the pivot shaft abuts movably under a second tongue sheet of the second arch bridge structure, for making the keycap movable upward and downward.

### BACKGROUND OF THE INVENTION

### 1. Field of the Invention

The present invention relates to a keyswitch and a keyboard thereof, and more specifically, to a keyswitch forming an avoiding notch on a support member of a lifting mechanism to accommodate a function keyswitch cooperatively with a recessed corner of a keycap and a keyboard thereof.

### 2. Description of the Prior Art

A keyboard, which is the most common input device, could be found in variety of electronic apparatuses for users to input characters, symbols, numerals and so on. Furthermore, from consumer electronic products to industrial machine tools, they are all equipped with a keyboard for performing input operations.

In practical applications, for further enhancing the operational convenience and functionality of the keyboard, function keyswitches could be additionally disposed between adjacent keyswitches on the keyboard. For example, a pointing stick has been widely utilized in keyboards of various computer devices (e.g., notebook computers) to facilitate user operations, such as moving a computer cursor or clicking a functional icon.

However, in the overall design of the keyboard, a certain amount of structural space is usually required to mount a lifting mechanism (e.g., a scissor-type lifting mechanism) for supporting a keycap of the keyswitch. Consequently, the aforementioned design of disposing the function keyswitch between the adjacent keyswitches often occupies additional space, which imposes numerous restrictions on the support design and arrangement of the keyswitches on the keyboard (for example, a gap between the adjacent keyswitches must be increased), so as to be disadvantageous to the thinning design of the keyboard.

### SUMMARY OF THE INVENTION

The present invention provides a keyswitch including a keycap, a lifting mechanism, and a baseplate. The keycap has a recessed corner. The lifting mechanism is disposed under the keycap and includes a first support member and a second support member. The first support member is movably connected to the keycap and has a sliding shaft. The first support member forms a first avoiding notch at a position corresponding to the recessed corner. The second support member is intersected with and pivotally connected to the first support member. The second support member is movably connected to the keycap and has a pivot shaft. The second support member forms a second avoiding notch at a position corresponding to the recessed corner, and the first avoiding notch and the second avoiding notch jointly provide an avoiding space to accommodate the recessed corner. The baseplate has a first hole structure and at least one second hole structure respectively corresponding to the sliding shaft and the pivot shaft. The baseplate bridges the first hole structure and the second hole structure to form a first arch bridge structure and a second arch bridge structure respectively, and the first arch bridge structure and the second arch bridge structure respectively extend a first tongue sheet and a second tongue sheet toward the sliding shaft and the pivot shaft. The sliding shaft movably abuts under the first tongue sheet and is slidable and rotatable against the baseplate, and the pivot shaft movably abuts under the second tongue sheet and is rotatable against the baseplate, such that the keycap is movable upward and downward relative to the baseplate via the lifting mechanism.

The present invention further provides a keyboard including at least two keyswitches arranged side by side and a function keyswitch. Each keyswitch includes a keycap, lifting mechanism, and a baseplate. The keycap has a recessed corner. The lifting mechanism is disposed under the keycap and includes a first support member and a second support member. The first support member is movably connected to the keycap and has a sliding shaft. The first support member forms a first avoiding notch at a position corresponding to the recessed corner. The second support member is intersected with and pivotally connected to the first support member. The second support member is movably connected to the keycap and has a pivot shaft. The second support member forms a second avoiding notch at a position corresponding to the recessed corner, and the first avoiding notch and the second avoiding notch jointly provide an avoiding space to accommodate the recessed corner. The baseplate has a first hole structure and at least one second hole structure respectively corresponding to the sliding shaft and the pivot shaft. The baseplate bridges the first hole structure and the second hole structure to form a first arch bridge structure and a second arch bridge structure respectively, and the first arch bridge structure and the second arch bridge structure respectively extend a first tongue sheet and a second tongue sheet toward the sliding shaft and the pivot shaft. The function keyswitch is at least partially accommodated in the recessed corners of the at least two keyswitches. The sliding shaft movably abuts under the first tongue sheet and is slidable and rotatable against the baseplate, and the pivot shaft movably abuts under the second tongue sheet and is rotatable against the baseplate, such that the keycap is movable upward and downward relative to the baseplate via the lifting mechanism.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial enlarged diagram of a keyboard according to an embodiment of the present invention.

FIG. 2 is an exploded view of a keyswitch in FIG. 1.

FIG. 3 is a top view of a lifting mechanism in FIG. 2 being connected to the baseplate 14.

FIG. 4 is a partial enlarged diagram of a first support member 22 in FIG. 2 being connected to the baseplate 14.

FIG. 5 is a partial enlarged diagram of a second support member 24 in FIG. 2 being connected to the baseplate 14.

### DETAILED DESCRIPTION

The present invention will now be described more specifically with reference to the following embodiments and the accompanying drawings. Other advantages and effects of the present invention can be easily understood by a person ordinarily skilled in the art in view of the detailed descriptions and the accompanying drawings. The present invention can be implemented or applied to other different embodiments. Certain aspects of the present invention are not limited by the particular details of the examples illustrated herein. Without departing from the spirit and scope of the present invention, the present invention will have other modifications and changes. It should be understood that the appended drawings are not necessarily drawn to scale and the configuration of each component (e.g., arrangement of keyswitches and functional keyswitches) in the drawings is merely illustrative, not presenting an actual condition of the embodiments.

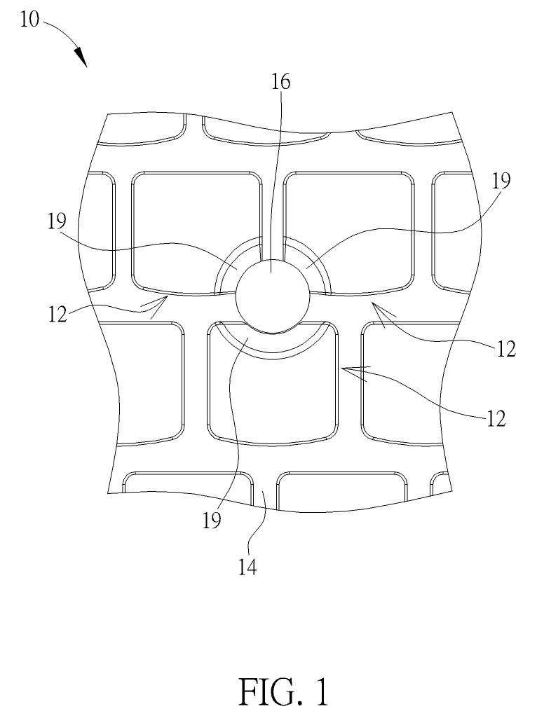

Please refer to FIG. 1, which is a partial enlarged diagram of a keyboard 10 according to an embodiment of the present invention. As shown in FIG. 1, the keyboard 10 includes at least two keyswitches 12 (three keyswitches 12 adjacent to a function keyswitch 16 with other keyswitches partially shown in FIG. 1, but not limited thereto), a baseplate 14, and the function keyswitch 16. The keyswitches 12 are arranged side by side on the baseplate 14 for a user to press and execute a desired input function. The function keyswitch 16 could be a specific function keyswitch commonly disposed between keyswitches on a keyboard, such as a pointing stick, to facilitate input operations, such as moving a computer cursor or clicking a functional icon. The keyboard 10 is preferably applied to a portable electronic device having a foldable mechanism composed of an upper cover and a lower casing (e.g., a notebook computer or a foldable keyboard), but the present invention is not limited thereto. For example, the keyboard 10 could also be applied to a desktop computer keyboard. To be noted, the keyswitch arrangement and quantity may vary according to the actual application requirements of the keyboard 10. For example, in another embodiment, through a more compact arrangement, the present invention could utilize an avoiding space jointly formed by recessed corners of only two adjacent keyswitches to accommodate the function keyswitch.

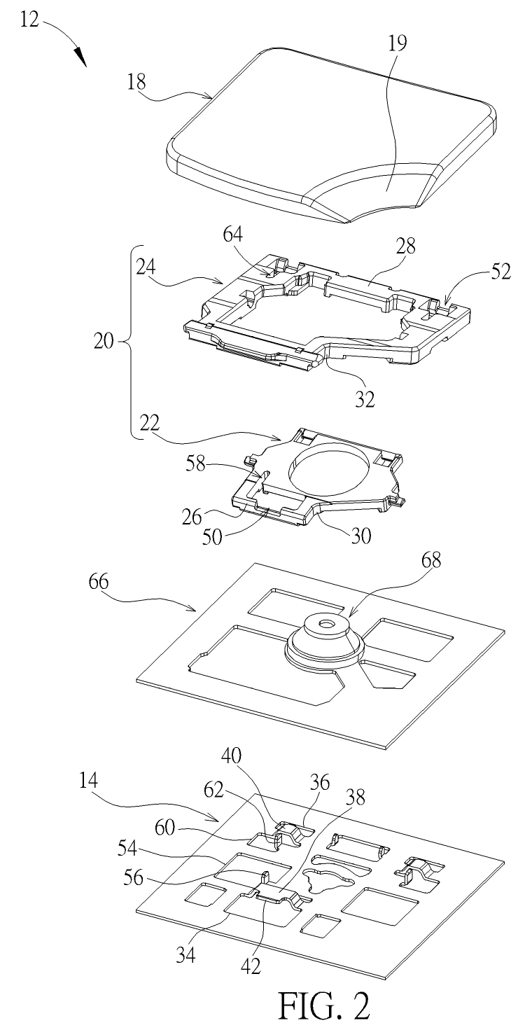

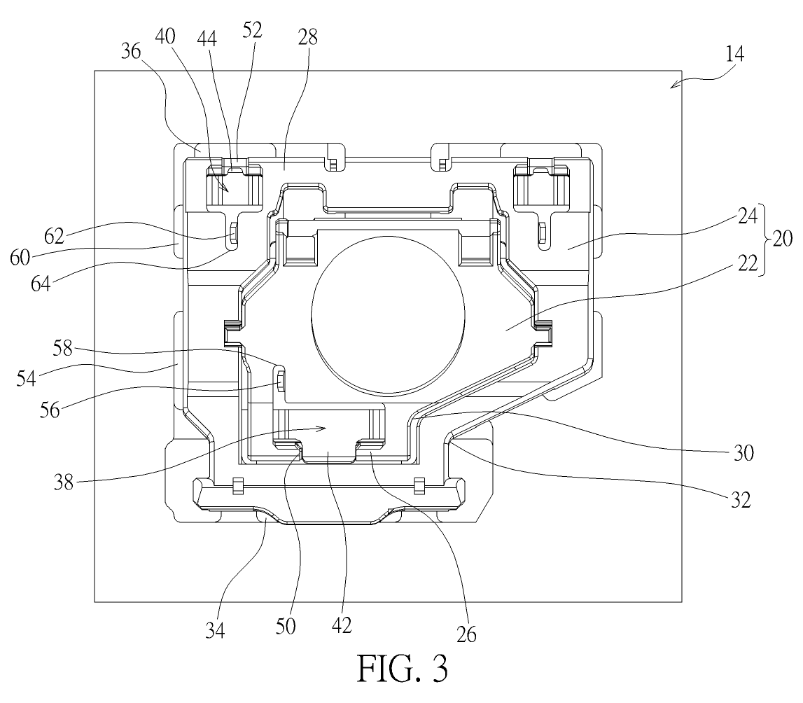

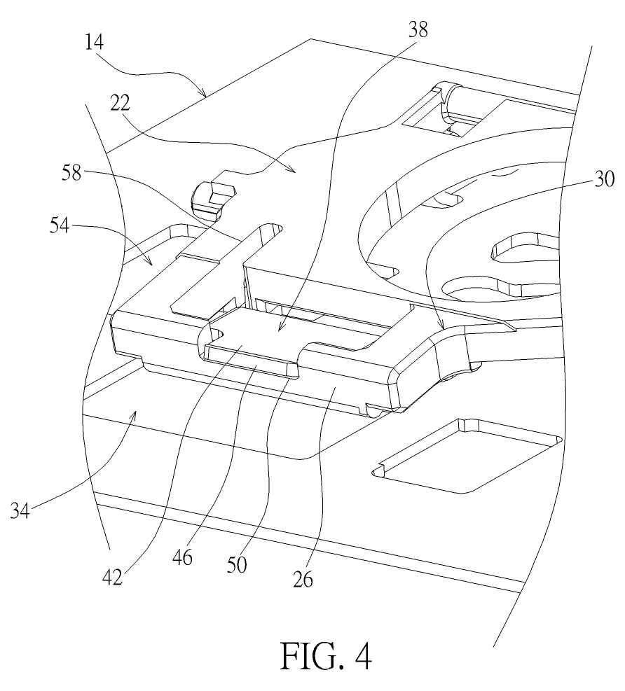

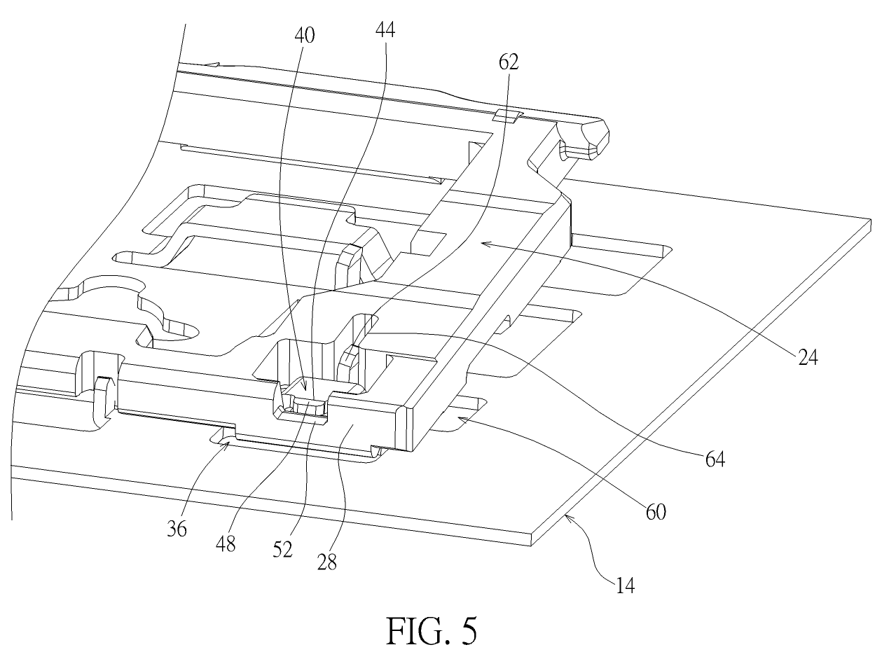

The keyswitch 12 preferably adopts an arch-bridge lifting design to enhance the structural deformation resistance of the baseplate 14 when the baseplate 14 is connected to a lifting mechanism, and utilizes a recessed keycap design to generate an avoiding space for mounting the function keyswitch 16. Detailed description for the keyswitch 12 located at an upper-left corner position of the function keyswitch 16 in FIG. 1 is provided as follows, and the related description for other keyswitches 12 adopting the similar design could be reasoned by analogy and omitted herein. Please refer to FIGS. 2, 3, 4, and 5. FIG. 2 is an exploded view of the keyswitch 12 in FIG. 1. FIG. 3 is a top view of a lifting mechanism 20 in FIG. 2 being connected to the baseplate 14. FIG. 4 is a partial enlarged diagram of a first support member 22 in FIG. 2 being connected to the baseplate 14. FIG. 5 is a partial enlarged diagram of a second support member 24 in FIG. 2 being connected to the baseplate 14. As shown in FIGS. 1-5, the keyswitch 12 includes the baseplate 14, a keycap 18, and the lifting mechanism 20. The keycap 18 has a recessed corner 19. The lifting mechanism 20 is disposed under the keycap 18 and includes the first support member 22 and the second support member 24. The first support member 22 is movably connected to the keycap 18 and has a sliding shaft 26. The second support member 24 and the first support member 22 are intersected with and pivotally connected to each other. The second support member 24 is movably connected to the keycap 18 and has a pivot shaft 28. A first avoiding notch 30 and a second avoiding notch 32 are respectively formed on the first support member 22 and the second support member 24 at positions corresponding to the recessed corner 19. As such, the first avoiding notch 30 and the second avoiding notch 32 jointly provide an avoiding space to accommodate the recessed corner 19 of the keycap 18, thereby achieving the effect of directly creating an avoiding space between the keyswitches 12 for mounting the function keyswitch 16 (as shown in FIG. 1).

The baseplate 14 has a first hole structure 34 and at least one second hole structure 36 (two shown in FIG. 2, but not limited thereto, meaning that the number of the hole structures depends on the connection configuration between the lifting mechanism 20 and the baseplate 14) respectively corresponding to the sliding shaft 26 and the pivot shaft 28. The baseplate 14 bridges the first hole structure 34 and the second hole structure 36 to form a first arch bridge structure 38 and a second arch bridge structure 40, respectively (e.g., by a stamping process, but not limited thereto). The first arch bridge structure 38 and the second arch bridge structure 40 extend a first tongue sheet 42 and a second tongue sheet 44 toward the sliding shaft 26 and the pivot shaft 28, respectively.

To be more specific, the first tongue sheet 42 is tilted upward relative to the baseplate 14 to form a guide sheet portion 46 (as shown in FIG. 4), and the second tongue sheet 44 is tilted downward relative to the baseplate 14 to form a guide sheet portion 48 (as shown in FIG. 5). Accordingly, the sliding shaft 26 can be guided by the upward-tilted structure of the guide sheet portion 46 to smoothly enter space below the first tongue sheet 42 and abut under the first tongue sheet 42. Similarly, the pivot shaft 28 can be guided by the downward-tilted structure of the guide sheet portion 48 to smoothly enter space below the second tongue sheet 44 and be engaged with the second tongue sheet 44, thereby assisting the user in completing assembly of the baseplate 14 with the first support member 22 and the second support member 24 more efficiently.

Furthermore, to guide the structural movement of the first support member 22 and the second support member 24 on the baseplate 14 more steadily, a first groove 50 could be formed on the sliding shaft 26 at a position corresponding to the first tongue sheet 42 to accommodate the first tongue sheet 42, so as to guide the sliding shaft 26 to slide and rotate smoothly without structural collision or interference. Similarly, a second groove 52 could be formed on the pivot shaft 28 at a position corresponding to the second tongue sheet 44 to accommodate the second tongue sheet 44, so as to guide the pivot shaft 28 to rotate smoothly without structural collision or interference. Preferably, a length of the first tongue sheet 42 is greater than a length of the second tongue sheet 44.

In addition, the baseplate 14 could further have a communication hole structure 54 extending from the first hole structure 34 toward the second hole structure 36. The communication hole structure 54 is communicated with the first hole structure 34. The communication hole structure 54 is bent upward at a position corresponding to the first arch bridge structure 38 to form a limiting sheet 56, and the first support member 22 has a limiting notch 58 corresponding to the limiting sheet 56. Thus, the limiting sheet 56 can be accommodated in the limiting notch 58 to limit the first support member 22 on the baseplate 14. Similarly, the baseplate 14 could further have a communication hole structure 60 extending from the second hole structure 36 toward the first hole structure 34. The communication hole structure 60 is communicated with the second hole structure 36. The communication hole structure 60 is bent upward at a position corresponding to the second arch bridge structure 40 to form a limiting sheet 62, and the second support member 24 has a limiting notch 64 corresponding to the limiting sheet 62. Thus, the limiting sheet 62 can be accommodated in the limiting notch 64 to limit the second support member 24 on the baseplate 14. Via the aforesaid limiting design, the first support member 22 and the second support member 24 can move up and down more steadily relative to the baseplate 14, so as to further enhance the operational stability of the lifting mechanism 20 and the tactile feedback of the keyswitch 12.

To be noted, as shown in FIG. 2, the keyswitch 12 could further include a membrane circuit board 66 disposed on the baseplate 14. When the keycap 18 is pressed to a pressed position, a switch (omitted in FIG. 2) on the membrane circuit board 66 is correspondingly triggered by a triggering portion (omitted in FIG. 2), allowing the keyswitch 12 to execute a desired input function. Additionally, the keyswitch 12 could include an elastic body 68 disposed between the keycap 18 and the baseplate 14 to provide an elastic recovery force to the keycap 18 and trigger the switch on the membrane circuit board 66 when the keycap 18 is pressed. The related description for the elastic body design and the triggering design of the keyswitch 12 is omitted herein since it is commonly seen in the prior art.

Via the aforementioned design, during the assembly process, the user just needs to align the sliding shaft 26 of the first support member 22 with the space below the first tongue sheet 42 of the first arch bridge structure 38 and then laterally latch the sliding shaft 26 into the space, so that the sliding shaft 26 can movably abut under the first tongue sheet 42 and be slidable and rotatable against the baseplate 14 (as shown in FIG. 4). Subsequently, the user can press the pivot shaft 28 of the second support member 24 down and latched the pivot shaft 28 into the space below the second tongue sheet 44 of the second arch bridge structure 40, so that the pivot shaft 28 could be movably engaged with the second tongue sheet 44 and be rotatable against the baseplate 14 (as shown in FIG. 5). In such a manner, assembly of the lifting mechanism 20 and the baseplate 14 can be completed quickly and easily for allowing the keycap 18 connected to the lifting mechanism 20 to move up and down relative to the baseplate 14, thereby enabling the keyboard 10 to execute a desired input function when the keycap 18 is pressed.

In summary, the present invention adopts the avoiding design in which the avoiding notch is directly formed on the support member of the lifting mechanism and the recessed corner is directly formed on the keycap to jointly create an avoiding space for mounting the function keyswitch. As such, the present invention can effectively solve the prior art problem that adding the function keyswitch occupies extra space and imposes numerous restrictions on the support design and arrangement of the keyswitches on the keyboard (for example, a gap between the adjacent keyswitches must be increased), so as to be advantageous to the thinning design of the keyboard. Furthermore, the present invention adopts the arch-bridge lifting design to enhance the structural deformation resistance of the baseplate when the baseplate is connected to the lifting mechanism, so as to effectively prevent deformation of the baseplate caused by structural pulling or pushing during the assembly or disassembly process of the lifting mechanism.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A keyswitch comprising:
a keycap having a recessed corner;
a lifting mechanism disposed under the keycap, the lifting mechanism comprising:
a first support member movably connected to the keycap and having a sliding shaft, the first support member forming a first avoiding notch at a position corresponding to the recessed corner; and
a second support member intersected with and pivotally connected to the first support member, the second support member being movably connected to the keycap and having a pivot shaft, the second support member forming a second avoiding notch at a position corresponding to the recessed corner, and the first avoiding notch and the second avoiding notch jointly providing an avoiding space to accommodate the recessed corner; and
a baseplate having a first hole structure and at least one second hole structure respectively corresponding to the sliding shaft and the pivot shaft, the baseplate bridging the first hole structure and the second hole structure to form a first arch bridge structure and a second arch bridge structure respectively, and the first arch bridge structure and the second arch bridge structure respectively extending a first tongue sheet and a second tongue sheet toward the sliding shaft and the pivot shaft;
wherein the sliding shaft movably abuts under the first tongue sheet and is slidable and rotatable against the baseplate, and the pivot shaft movably abuts under the second tongue sheet and is rotatable against the baseplate, such that the keycap is movable upward and downward relative to the baseplate via the lifting mechanism.

2. The keyswitch of claim 1, wherein the first tongue sheet is tilted upward relative to the baseplate to form a guide sheet portion for guiding the sliding shaft to be engaged with the first tongue sheet.

3. The keyswitch of claim 1, wherein the second tongue sheet is tilted downward relative to the baseplate to form a guide sheet portion for guiding the pivot shaft to be engaged with the second tongue sheet.

4. The keyswitch of claim 1, wherein a length of the first tongue sheet is greater than a length of the second tongue sheet.

5. The keyswitch of claim 1, wherein the baseplate has a communication hole structure extending from the first hole structure toward the second hole structure, the communication hole structure is communicated with the first hole structure and has a limiting sheet bent upward at a position corresponding to the first arch bridge structure, the first support member forms a limiting notch at a position corresponding to the limiting sheet, and the limiting sheet is accommodated in the limiting notch to limit the first support member on the baseplate.

6. The keyswitch of claim 1, wherein the baseplate has a communication hole structure extending from the second hole structure toward the first hole structure, the communication hole structure is communicated with the second hole structure and has a limiting sheet bent upward at a position corresponding to the second arch bridge structure, the second support member forms a limiting notch at a position corresponding to the limiting sheet, and the limiting sheet is accommodated in the limiting notch to limit the second support member on the baseplate.

7. The keyswitch of claim 1, wherein a first groove is formed on the sliding shaft at a position corresponding to the first tongue sheet for accommodating the first tongue sheet, and a second groove is formed on the pivot shaft at a position corresponding to the second tongue sheet for accommodating the second tongue sheet.

8. The keyswitch of claim 1 further comprising:
a membrane circuit board disposed on the baseplate;
wherein when the keycap is pressed, a switch on the membrane circuit board at a position corresponding to the keyswitch is triggered.

9. The keyswitch of claim 8 further comprising:
an elastic body disposed between the keycap and the membrane circuit board, for providing an elastic recovery force to the keycap and triggering the switch when the keycap is pressed.

10. A keyboard comprising:
at least two keyswitches arranged side by side, each keyswitch comprising:
a keycap having a recessed corner;
a lifting mechanism disposed under the keycap, the lifting mechanism comprising:
a first support member movably connected to the keycap and having a sliding shaft, the first support member forming a first avoiding notch at a position corresponding to the recessed corner; and
a second support member intersected with and pivotally connected to the first support member, the second support member being movably connected to the keycap and having a pivot shaft, the second support member forming a second avoiding notch at a position corresponding to the recessed corner, and the first avoiding notch and the second avoiding notch jointly providing an avoiding space to accommodate the recessed corner; and
a baseplate having a first hole structure and at least one second hole structure respectively corresponding to the sliding shaft and the pivot shaft, the baseplate bridging the first hole structure and the second hole structure to form a first arch bridge structure and a second arch bridge structure respectively, and the first arch bridge structure and the second arch bridge structure respectively extending a first tongue sheet and a second tongue sheet toward the sliding shaft and the pivot shaft; and
a function keyswitch at least partially accommodated in the recessed corners of the at least two keyswitches;
wherein the sliding shaft movably abuts under the first tongue sheet and is slidable and rotatable against the baseplate, and the pivot shaft movably abuts under the second tongue sheet and is rotatable against the baseplate, such that the keycap is movable upward and downward relative to the baseplate via the lifting mechanism.

11. The keyboard of claim 10, wherein the first tongue sheet is tilted upward relative to the baseplate to form a guide sheet portion for guiding the sliding shaft to be engaged with the first tongue sheet.

12. The keyboard of claim 10, wherein the second tongue sheet is tilted downward relative to the baseplate to form a guide sheet portion for guiding the pivot shaft to be engaged with the second tongue sheet.

13. The keyboard of claim 10, wherein a length of the first tongue sheet is greater than a length of the second tongue sheet.

14. The keyboard of claim 10, wherein the baseplate has a communication hole structure extending from the first hole structure toward the second hole structure, the communication hole structure is communicated with the first hole structure and has a limiting sheet bent upward at a position corresponding to the first arch bridge structure, the first support member forms a limiting notch at a position corresponding to the limiting sheet, and the limiting sheet is accommodated in the limiting notch to limit the first support member on the baseplate.

15. The keyboard of claim 10, wherein the baseplate has a communication hole structure extending from the second hole structure toward the first hole structure, the communication hole structure is communicated with the second hole structure and has a limiting sheet bent upward at a position corresponding to the second arch bridge structure, the second support member forms a limiting notch at a position corresponding to the limiting sheet, and the limiting sheet is accommodated in the limiting notch to limit the second support member on the baseplate.

16. The keyboard of claim 10, wherein a first groove is formed on the sliding shaft at a position corresponding to the first tongue sheet for accommodating the first tongue sheet, and a second groove is formed on the pivot shaft at a position corresponding to the second tongue sheet for accommodating the second tongue sheet.

17. The keyboard of claim 10, wherein each keyswitch further comprises:
a membrane circuit board disposed on the baseplate;
wherein when the keycap is pressed, a switch on the membrane circuit board at a position corresponding to the keyswitch is triggered.

18. The keyboard of claim 17, wherein each keyswitch further comprises:
an elastic body disposed between the keycap and the membrane circuit board, for providing an elastic recovery force to the keycap and triggering the switch when the keycap is pressed.
